(19) United States
(12) Patent Application Publication
(10) Pub. No.: US 2025/0355245 A1
(43) Pub. Date: Nov. 20, 2025

(54) HANDHELD MAGNIFIER WITH ADJUSTABLE FOCAL LENGTH

(71) Applicant: Shenzhen Maikelong Technology Co., Ltd., Shenzhen (CN)

(72) Inventor: Guojun Chen, Shenzhen (CN)

(21) Appl. No.: 19/291,574

(22) Filed: Aug. 5, 2025

(30) Foreign Application Priority Data
Jun. 17, 2025 (CN) 2025212358209

(51) Int. Cl. G02B 27/00; G02B 25/02; G02B 27/02

(52) U.S. Cl. CPC G02B 27/0075; G02B 27/025; G02B 27/026; G02B 25/02

(57) ABSTRACT

To achieve the above objective, the present invention provides the following technical solution: a handheld magnifier with an adjustable focal length, comprising an upper shell and a lower shell. The upper shell is equipped with a protection plate, a display screen, and a silicone key, while the lower shell contains a PVC film. A battery, a keyboard, a main board, a wave wheel, a sector gear, a lens assembly, and a light board are installed between the upper and lower shells. The lens assembly consists of an FPC cable, a chip, a guide fixing seat, a roller, a lens holder, a lens cover, and a glass sheet. Manual precise focusing is achieved through a mechanical transmission structure consisting of a wave wheel, sector gear, and spiral groove. This structure provides a wide adjustable range of clarity to accommodate observation needs at different distances.

### TECHNICAL FIELD

The present invention relates to the technical field of magnifiers, specifically to a handheld magnifier with an adjustable focal length.

### BACKGROUND ART

Handheld magnifiers are tools that enlarge the images of objects using short-focal-length lenses, primarily for detailed observation.

Conventional handheld magnifiers typically have fixed focal length designs. These designs cannot be adjusted to achieve clarity requirements at varying observation distances. They also lack real-time image display capabilities, forcing users to view objects up close. As a result, they are easily limited by lighting conditions and viewing angles. Some focus-adjustable products adopt complex electric structures, resulting in bulky volumes and high costs that compromise portability and affordability.

### Summary of the Utility Model

### Technical Problem to be Solved

To address the drawbacks in the prior art, the present invention provides a handheld magnifier with an adjustable focal length.

### Technical Solution

Further, in the improvement of the present invention, the FPC cable connects the chipboard to the main board in the lens assembly.

Further, in the improvement of the present invention, the gear on the wave wheel meshes with the sector gear, which drives the swinging member to rotate. The swinging member then converts this rotational motion into the linear motion of the lens holder through a spiral groove.

Further, in the improvement of the present invention, the display screen is a 2.0-inch display screen used for the real-time display of image data processed by the main board.

Further, in the improvement of the present invention, the light board is positioned around the lens assembly to provide auxiliary illumination.

Further, in the improvement of the present invention, the PVC film of the lower shell is used to protect internal components and enhance handheld anti-slip properties.

### Advantageous Effects

Compared to prior art, the present invention offers a handheld magnifier with an adjustable focal length, having the following advantages:

Adjustable Focus Design: The mechanical transmission structure of the wave wheel-sector gear-spiral groove enables precise manual focusing, adapting to observation needs at different distances with a wide range of clarity adjustment.

Real-Time Image Display: The 2.0-inch display screen directly shows an enlarged image, reducing user eye strain from close observation and making it suitable for long-term use.

Compact and Portable Structure: The modular design of the upper and lower shells integrates internal components efficiently, resulting in a compact overall size that is easy to carry by hand.

Multifunctional Assistance: The light board provides illumination for low-light environments, while the PVC film enhances anti-slip properties and protection, improving safety during use.

### BRIEF DESCRIPTION OF THE DRAWINGS

FIG. 1 is a schematic diagram of the overall structure of the present invention.

FIG. 2 is an exploded structural view of each component of the present invention.

FIG. 3 is a structural view of the lens assembly of the present invention.

FIG. 4 is a mounting structural view of the TF card, charging interface, wave wheel, and light board of the present invention.

Reference signs: 1. Silicone key; 2. Protection plate; 3. Upper shell; 4. Battery; 5. Keyboard; 6. Display screen; 7. Main board; 8. Wave wheel; 9. Sector gear; 10. Lens assembly; 11. Light board; 12. Lower shell; 13. PVC film; 14. Roller; 15. Lens holder; 16. Lens body (16); 17. Lens cover; 18. Glass sheet; 19. TF card; 20. Charging interface; 21. FPC cable; 22. Chip; 23. Guide fixing seat.

### DETAILED DESCRIPTION OF THE UTILITY MODEL

The technical solutions provided in the embodiments of the present invention are clearly and completely described below with reference to the drawings in the embodiments of the present invention. It is important to note that the described embodiments represent only a part of the embodiments of the present invention, not all embodiments. All other embodiments obtained by those of ordinary skill in the art without creative efforts are intended to fall within the protection scope of the present invention.

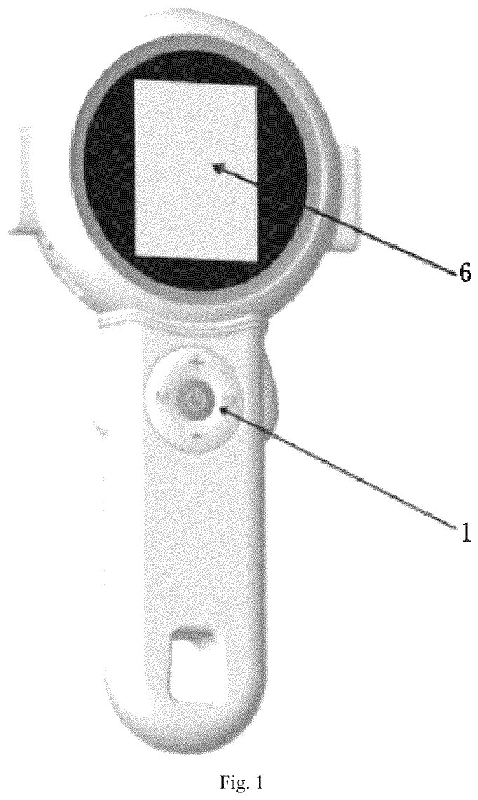

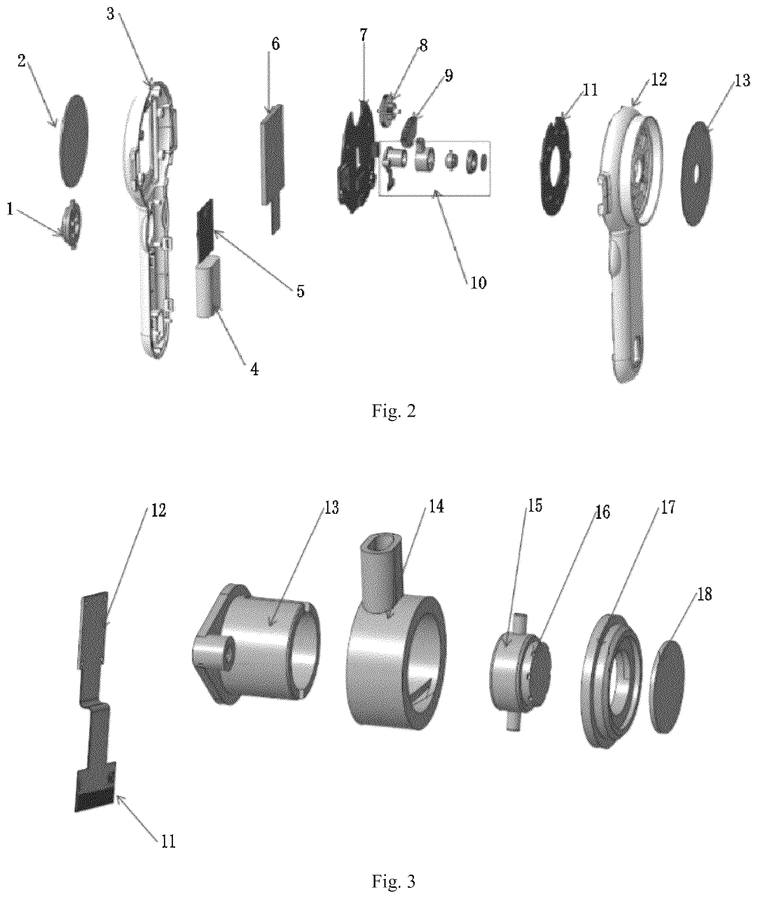

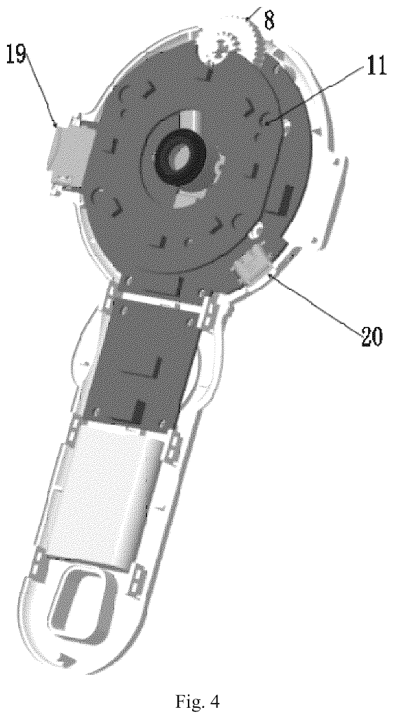

Referring to FIGS. 1 to 4, the handheld magnifier with an adjustable focal length of the present invention consists of an upper shell (3) and a lower shell (12). The upper shell (3) is equipped with a protection plate (2), a display screen (6), and a silicone key (1), while the lower shell (12) contains a PVC film (13). A battery (4), a keyboard (5), a main board (7), a wave wheel (8), a sector gear (9), a lens assembly (10), and a light board (11) are installed between the upper (3) and the lower shells (12). The lens assembly (10) consists of an FPC cable (21), a chip (22), a guide fixing seat (23), a roller (14), a lens holder (15), a lens cover (17), and a glass sheet (18). Focusing is achieved by rotating the wave wheel (8), which drives the sector gear (9) to swing, thereby moving the lens holder (15) up and down.

In the lens assembly (10), the FPC cable (21) connects the chip (22) board to the main board (7). The chip (22) receives image data collected by the lens and transmits it to the main board (7) for processing.

The gear on the wave wheel (8) meshes with the sector gear (9). The sector gear (9) drives the swinging member to rotate, which then converts this rotational motion into the linear motion of the lens holder (15) through the spiral groove.

The display screen (6) is a 2.0-inch display screen that shows real-time image data processed by the main board (7).

The light board (11) is positioned around the lens assembly (10) to provide auxiliary illumination.

The PVC film (13) of the lower shell (12) is used to protect internal components and enhance handheld anti-slip properties.

The main body of the handheld magnifier consists of the upper shell (3) and the lower shell (12). A 2.0-inch display screen is embedded on the surface of the upper shell (3) and covered by the protection plate (2). A silicone key (1) is positioned on the side for functional control. A PVC film (13) is pasted on the inner side of the lower shell (12), providing both waterproofing and anti-slip properties. Inside the cavity formed by the upper and lower shells (12), the battery (4) and the keyboard (5) are installed adjacent to each other, with the main board (7) located centrally. The lens assembly (10) is connected through an FPC cable (21). Within the lens assembly (10), the guide fixing seat (23) and roller (14) work together to define the movement path of the lens holder (15), while the lens cover (17) and glass sheet (18) form the front-end optical structure.

During focusing, the wave wheel (8) on the side is rotated, causing its peripheral gear to drive the sector gear (9) to swing. The sector gear (9) then drives the swinging member to rotate through a pin shaft. The spiral groove on the side wall of the swinging member cooperates with the guidepost of the lens holder (15) to convert the rotational motion into vertical lifting of the lens holder (15), thereby realizing focal length adjustment from 0.5 to 10 cm. The image captured by the lens is processed by the chip (22), transmitted to the main board (7) through the FPC cable (21), and displayed in real-time on the display screen (6). The light board (11) is positioned around the lens holder (15), which is activated by a key to provide uniform illumination.

Cost Economy: The pure mechanical focusing structure replaces the electric scheme, reducing production costs while lowering failure points and improving reliability.

Wide Application Scenarios: It is suitable for various scenarios such as literature reading, jewelry appraisal, circuit board maintenance, etc., effectively meeting the detailed observation needs of different users.

It should be noted that, in the description of this document, relational terms such as “first” and “second” are only used to distinguish one entity or operation from another. These terms do not necessarily require or imply any actual relationship or order between the entities or operations. Moreover, the terms “comprise,” “include,” or their variants thereof are intended to denote non-exclusive inclusion. Therefore, a process, method, article, or device described as comprising a series of elements not only includes those elements but may also contain other elements not explicitly listed or elements inherent to the process, method, article, or device.

Although the embodiments of the present invention have been shown and described in detail, those of ordinary skill in the art will understand that various changes, modifications, substitutions, and variations are possible. Such alterations can be made to these embodiments without departing from the principles and spirit of the present invention.

What is claimed is:

1. A handheld magnifier with adjustable focal length, comprising:
an upper shell (3) and a lower shell (12), wherein the upper shell (3) is equipped with a protection plate (2), a display screen (6), and a silicone key (1), while the lower shell (12) contains a PVC film (13).
A battery (4), a keyboard (5), a main board (7), a wave wheel (8), a sector gear (9), a lens assembly (10), and a light board (11) are installed between the upper (3) and the lower shells (12). The lens assembly (10) consists of an FPC cable (21), a chip (22), a guide fixing seat (23), a roller (14), a lens holder (15), a lens cover (17), and a glass sheet (18).

2. The handheld magnifier according to claim 1, wherein in the lens assembly (10), the FPC cable (21) connects the chip (22) board to the main board (7).

3. The handheld magnifier according to claim 2, wherein a gear on the wave wheel (8) meshes with the sector gear (9). The sector gear (9) drives the swinging member to rotate, which then converts this rotational motion into the linear motion of the lens holder (15) through a spiral groove.

4. The handheld magnifier according to claim 3, wherein the display screen (6) is a 2.0-inch display screen.

5. The handheld magnifier according to claim 4, wherein the light board (11) is positioned around the lens assembly (10).

6. The handheld magnifier of claim 5, wherein the PVC film (13) of the lower shell (12) is used to protect internal components.
To achieve the above objective, the present invention provides the following technical solution: a handheld magnifier with an adjustable focal length, comprising an upper shell and a lower shell. The upper shell is equipped with a protection plate, a display screen, and a silicone key, while the lower shell contains a PVC film. A battery, a keyboard, a main board, a wave wheel, a sector gear, a lens assembly, and a light board are installed between the upper and lower shells. The lens assembly consists of an FPC cable, a chip, a guide fixing seat, a roller, a lens holder, a lens cover, and a glass sheet. Manual precise focusing is achieved through a mechanical transmission structure consisting of a wave wheel, sector gear, and spiral groove. This structure provides a wide adjustable range of clarity to accommodate observation needs at different distances.
